(19) United States
(12) Patent Application Publication
(10) Pub. No.: US 2016/0337585 A1
(43) Pub. Date: Nov. 17, 2016

(54) VIDEO SIGNAL EXTENDER

(71) Applicants: Gary Blaine Clinton, Belvidere, IL (US); Daniel Blaine Clinton, Loves Park, IL (US)

(72) Inventors: Gary Blaine Clinton, Belvidere, IL (US); Daniel Blaine Clinton, Loves Park, IL (US)

(73) Assignee: CLINTON ELECTRONICS CORPORATION, Loves Park, IL (US)

(21) Appl. No.: 14/710,982

(22) Filed: May 13, 2015

(51) Int. Cl. H04N 5/232; H04N 5/63; H04N 5/225; G06K 9/00; H04N 5/77

(52) U.S. Cl. CPC H04N 5/23241; G06K 9/00771; H04N 5/77; H04N 5/2252; H04N 5/63

(57) ABSTRACT

A video signal extender includes a housing that includes only a single power supply input configured to receive electrical power, a power supply output configured to provide power to a remotely located camera, and a video signal output configured to relay the video signal from the camera to a monitor or video recording device.

### FIELD OF THE INVENTION

This invention generally relates to a video signal extender.

### BACKGROUND OF THE INVENTION

Video surveillance systems are commonly used in commercial, industrial, and government settings. In many cases, multiple remotely-located video cameras send captured video back to a central base of operations. Typically, the central base of operations includes one or more recording devices on which to store the captured video. Power may be routed from the central base of operations to each of the remotely-located video cameras.

When the distance between the remotely-located video cameras and the central base of operations is great, it is necessary to place a video signal extender between the camera and base of operations to prevent degradation of the video signal that would render it unwatchable. However, in conventional video surveillance systems, video signal extenders are powered from an external source, such as an electrical outlet. This often requires the installation of electrical outlets in remote locations where such installation is not normally done. This can add considerable cost and complexity to the construction and maintenance of the surveillance system.

It would therefore be desirable to have a video signal extender that provides a solution to the aforementioned problem. Embodiments of the invention provide such a video signal extender. These and other advantages of the invention, as well as additional inventive features, will be apparent from the description of the invention provided herein.

### BRIEF SUMMARY OF THE INVENTION

In one aspect, embodiments of the invention provide a video signal extender includes a housing that includes only a single power supply input configured to receive electrical power. The video signal extender also includes a power supply output configured to provide power to a remotely located camera, and a video signal output configured to relay the video signal from the camera to a monitor or video recording device.

In a particular embodiment, the video signal extender includes signaling means to indicate a power connection status. In some instances, the signaling means is an LED or light bulb. In a further embodiment, the video signal extender includes signaling means to indicate a video connection status. In certain instances, the signaling means is an LED or light bulb. The video signal extender may be plugless. It may also include circuitry for re-clocking the video signal from the video camera to the monitor or video recording device. In some embodiments, re-clocking the video signal includes routing the video signal through a cable equalizer, then through a cable driver that includes a re-clocking device.

In another aspect, embodiments of the invention provide a surveillance system that includes a display monitor or video recording device, and a video camera having a wired connection to the display monitor or video recording device. The surveillance system also has a video signal extender coupled between the video camera and the display monitor or video recording device. The video signal extender includes a housing that has only a single power supply input configured to receive electrical power. The video signal extender also includes a power supply output configured to provide power to a remotely located camera, and a video signal output configured to relay the video signal from the camera to a monitor or video recording device.

In certain embodiments, the video camera is located more than 275 feet from the display monitor or video recording device. In a further embodiment, a second video signal extender is coupled between the video camera and the display monitor or video recording device when the video camera is located more than 550 feet from the display monitor or video recording device. The video camera and display monitor or video recording device may be HD-SDI devices. In some embodiments of the surveillance system, re-clocking the video signal comprises routing the video signal through a cable equalizer, then through a cable driver that includes a re-clocking device.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a schematic block diagram of an exemplary video surveillance system incorporating a video signal extender, in accordance with an embodiment of the invention;

FIG. 2 is a front view of the video signal extender, according to an embodiment of the invention;

FIG. 3 is a side view of the video signal extender, according to an embodiment of the invention; and

FIG. 4 is a schematic drawing of circuitry used in the video signal extender, according to an embodiment of the invention.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

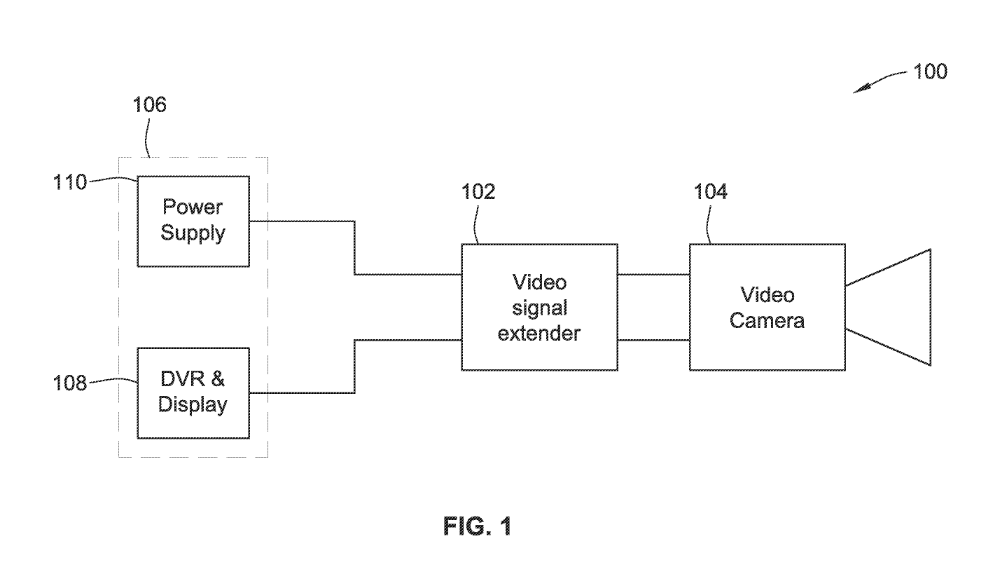

FIG. 1 shows a schematic block diagram of an exemplary video surveillance system 100 incorporating one or more video signal extenders 102, in accordance with an embodiment of the invention. Each of the one or more video signal extenders 102 is positioned between a respective video camera 104 and a central base of operations 106. The central base of operations 106 has one or more video recording devices (VRD) 108, such as a digital video recorder (DVR), and any associated display monitors, to store and display video captured by the one or more video cameras 104. In certain embodiments, one or more of the video camera 104, VRD, and display monitors are high-definition serial data interface (HD-SDI) devices. The central base of operations 106 also includes an electrical power supply 110 for each of the video cameras 104.

Typically, in video surveillance systems 100 such as that of FIG. 1, video cameras 104 can transmit signals along a coaxial cable, for example, up to 275 feet before the signal degrades to the point where it is unwatchable. In video surveillance systems 100 in which the distance between the video camera 104 and central base of operations 106 is greater than 275 feet, the video signal extender 102 is used to restore the video signal. Multiple video signal extenders 102 may be used when the distance between the video camera 104 and central base of operations 106 is greater than 550 feet. However, depending on the particular characteristics of the video surveillance systems 100, video signal extenders 102 may be required to restore the video signal at distances less than or greater than 275 feet.

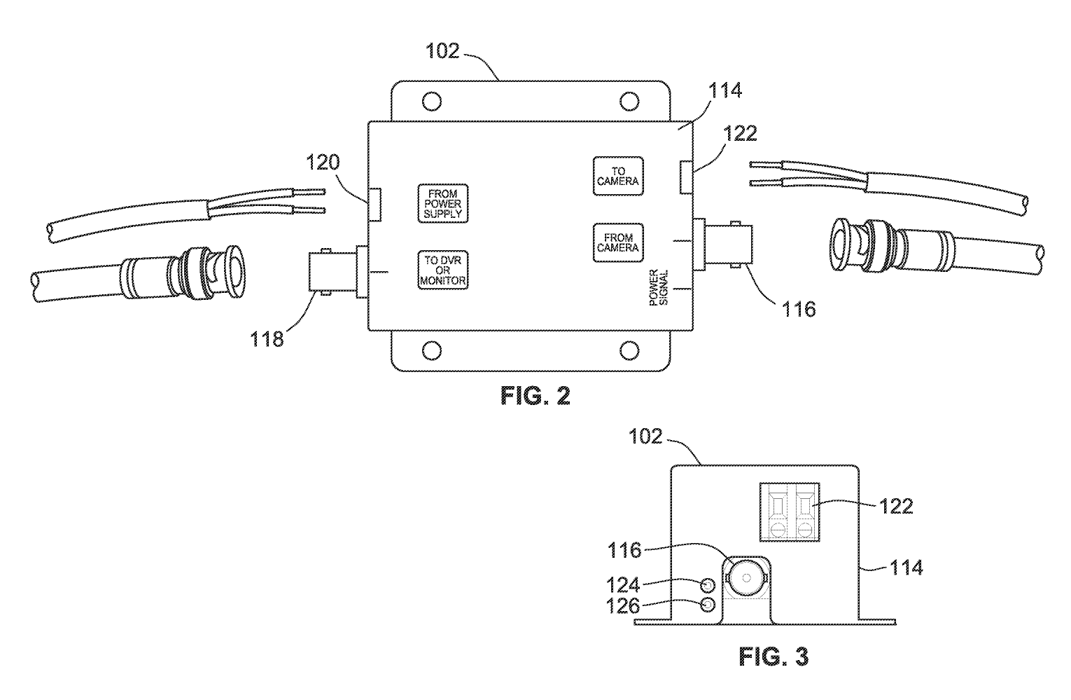

Unlike conventional video signal extenders, the video signal extender 102 of the present invention does not plug into an electrical outlet. Instead, the video signal extender 102 is powered by the same power supply 110 used to power the video cameras 104. FIGS. 2 and 3 illustrate front and side views, respectively, of a particular embodiment of the video signal extender 102. In the embodiment shown, the video signal extender 102 is plugless. Thus, the video signal extender 102 obtains all of the power needed for its own operation from power supply 110.

The video signal extender 102 includes a housing 114 with first and second ports 116, 118 having BNC connectors. First port 116 is a video input which receives the video signal transmitted by the video camera 104. Second port 118 is a video output which transmits the video signal to the base of operations 106 and its video recording devices 108 and associated displays. In alternate embodiments, first and second ports 116, 118 may include connectors other than BNC connectors.

In the embodiment shown, third and fourth ports 120, 122 include wire connectors. In certain embodiments, the wire connectors are push-in or quick-connect-type connectors which allow for a bare end of the wire to be inserted into the third and fourth port wire connectors. Third port 120 is for the power input from electrical power supply 110, while fourth port 122 is the power output to the video camera 104. In certain embodiments of the invention, the power input and output is 12 volts DC. In other embodiments, the power input and output are 24 volts AC. However, it is envisioned that the power input and output voltage levels could be greater or lesser than the levels cited above. It is further envisioned that these power input and output voltages can be either AC or DC.

The side view of FIG. 3 shows first and second visual signaling means, or LEDs 124, 126. First LED 124, when lit, indicates a good video connection. Second LED 126, when lit, indicates a good power connection. In some embodiments, the first and second LEDs 124, 124 are color-coded to be easily distinguishable. In alternate embodiments, visual signaling means other than LEDs may be used. A small light bulb or other suitable light-emitting device may be used.

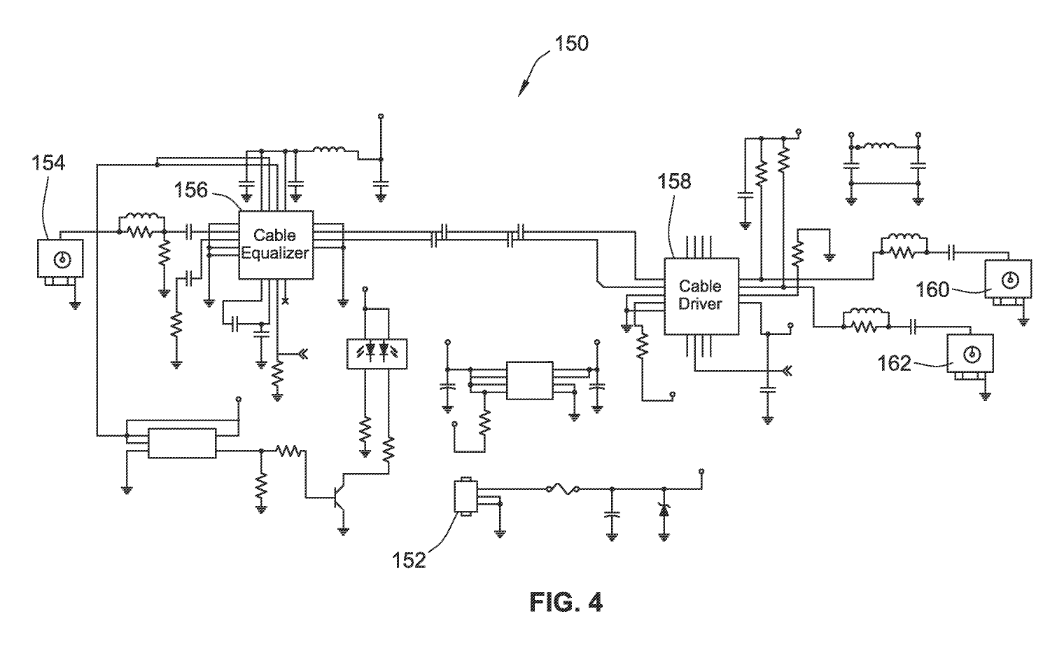

FIG. 4 shows a schematic diagram for an exemplary circuit design 150 for use in the video signal extender 102, according to an embodiment of the invention. In the embodiment shown, the circuit design 150 does not amplify the video signal from the video camera 104, but instead equalizes and re-clocks the video signal.

As the length of the video cable increases, so does the attenuation of the video signal being transmitted along the cable. The attenuation is proportional to the square root of the signal frequency. An active equalizer operates to automatically adjust the gain of the equalization so that the output of the equalizer is the same as the original signal. To efficiently recover the video signal, the equalizer may be designed to dynamically adjust its gain. Thus, a cable equalizer may be configured such that the attenuation of the video signal is determined, and further configured such that the gain adjustment is controlled via a feedback loop. This allows the cable equalizer to automatically adjust its gain so that a signal transmitted along various lengths of the video cable can be equalized.

However, even with equalization of the video signal, there can still be some signal degradation due to jitter. Jitter is the deviation of a signal's transitions in time from their ideal positions. Re-clocking a video signal can be thought of as “refreshing” or “regenerating” the signal. When a video signal is transmitted over a relatively long length of cable, the signal can suffer significant degradation. This signal degradation can take the form of noise and interference, decrease in amplitude, and most significantly “rounded edges” as the signal transitions from low-to-high or high-to-low (essentially low-pass filtering of the signal due to the capacitance of the cable). If this degradation becomes too severe, the video signal can be rendered unusable or unwatchable. To prevent this, a re-clocking device can be inserted in the signal chain. Typically, the re-clocking device uses the incoming signal as a template to regenerate a new signal with the same characteristics. Stated another way, re-clocking relies on the fact that the receiver knows the data-rate of the initial signal. The re-clocking device generates a stable, local clock at the known frequency, and re-clocks the signal coming out of the equalizer in order to reduce the accumulated jitter.

Referring again to FIG. 4, circuit design 150 includes power input 152 and video input 154. As can be seen from FIG. 4, the video signal from video camera 104 (shown in FIG. 1) is input at video input 154. The video signal is equalized by cable equalizer 156, which takes the video signal and sends the equalized output to cable driver 158. In the embodiment of FIG. 4, the cable drive 158 includes a re-clocking device. Cable driver 158 sends the re-clocked video signal to first video output 160. A second video output 162 is also provided.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A video signal extender comprising:
a housing that includes:
only a single power supply input configured to receive electrical power;
a power supply output configured to provide power to a remotely located camera; and
a video signal output configured to relay the video signal from the camera to a monitor or video recording device.

2. The video signal extender of claim 1, further comprising circuitry for re-clocking the video signal from the video camera to the monitor or video recording device.

3. The video signal extender of claim 2, wherein re-clocking the video signal comprises routing the video signal through a cable equalizer, then through a cable driver that includes a re-clocking device.

4. The video signal extender of claim 1, further comprising signaling means to indicate a power connection status.

5. The video signal extender of claim 4, wherein the signaling means is an LED or light bulb.

6. The video signal extender of claim 1, further comprising signaling means to indicate a video connection status.

7. The video signal extender of claim 6, wherein the signaling means is an LED or light bulb.

8. The video signal extender of claim 1, wherein the video signal extender is plugless.

9. A surveillance system comprising:
a display monitor or video recording device;
a video camera having a wired connection to the display monitor or video recording device;
a video signal extender coupled between the video camera and the display monitor or video recording device, the video signal extender comprising:
a housing that includes:
only a single power supply input configured to receive electrical power;
a power supply output configured to provide power to a remotely located camera; and
a video signal output configured to relay the video signal from the camera to a monitor or video recording device.

10. The surveillance system of claim 9, wherein the video camera is located more than 275 feet from the display monitor or video recording device.

11. The surveillance system of claim 10, wherein a second video signal extender is coupled between the video camera and the display monitor or video recording device when the video camera is located more than 550 feet from the display monitor or video recording device.

12. The surveillance system of claim 9, wherein at least one of the video camera, display monitor, and video recording device are HD-SDI devices.

13. The surveillance system of claim 9, further comprising signaling means to indicate a power connection status.

14. The surveillance system of claim 13, wherein the signaling means is an LED or light bulb.

15. The surveillance system of claim 9, further comprising signaling means to indicate a video connection status.

16. The surveillance system of claim 15, wherein the signaling means is an LED or light bulb.

17. The surveillance system of claim 9, wherein the video signal extender is plugless.

18. The surveillance system of claim 9, wherein the video signal extender includes circuitry for re-clocking the video signal from the video camera to the monitor or video recording device.

19. The surveillance system of claim 18, wherein re-clocking the video signal comprises routing the video signal through a cable equalizer, then through a cable driver that includes a re-clocking device.
